(19) United States
(12) Patent Application Publication
(10) Pub. No.: US 2019/0041853 A1
(43) Pub. Date: Feb. 7, 2019

(54) DISTRIBUTED COMPUTE METHOD, APPARATUS, AND SYSTEM

(71) Applicant: Intel Corporation, Santa Clara, CA (US)

(72) Inventors: Siddharth Jain, Hillsboro, OR (US); Ned M. Smith, Beaverton, OR (US); Nathan Heldt-Sheller, Portland, OR (US); Shantanu Kulkarni, Hillsboro, OR (US)

(21) Appl. No.: 16/023,637

(22) Filed: Jun. 29, 2018

(51) Int. Cl. G05D 1/00; G06F 9/50; G05D 1/02

(52) U.S. Cl. CPC G05D 1/0088; G06F 9/505; G05D 2201/0213; G05D 1/0285; G05D 1/0287; G06F 9/5083

(57) ABSTRACT

Apparatuses, methods, and systems for performing a distributed compute task by a computer-assisted or autonomous driving (CA/AD) vehicle are disclosed herein. In embodiments, an apparatus may include a communication interface disposed in the CA/AD vehicle to receive the compute task. In embodiments, the compute task is part of a collection of distributed compute tasks that are assigned to the CA/AD vehicle or other compute apparatuses based at least in part on resources available to the CA/AD vehicle and to the other computer apparatuses. In embodiments, a compute engine may perform the compute task using, at least in part, the available resources of the CA/AD vehicle. Other embodiments may be disclosed and claimed.

### TECHNICAL FIELD

The present disclosure relates to the fields of networking, distributed computing, and computer-assisted or autonomous driving vehicles, in particular, to methods, apparatuses, and systems associated with utilizing resources of autonomous or semi-autonomous vehicles for distributed computing.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Shared computing solutions may incur overhead costs due to scheduling, data locality, and synchronization requirements. Algorithms for managing distributed computing often do not scale well and available workloads may be more cost-effective using more traditional hosting environments. Furthermore, security and safety risks exist in terms of isolating the ‘normal’ workload from the ‘outsourced compute’ workload.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an arrangement showing interconnections that may be present between a network and Internet of Things (IoT) networks, in accordance with various embodiments;

FIG. 2 illustrates an example domain topology, in accordance with various embodiments;

FIG. 3 illustrates an example cloud computing network or cloud in communication with a number of IoT devices including one or more computer-assisted or autonomous driving (CA/AD) systems, in accordance with various embodiments;

FIG. 4 illustrates an arrangement of a cloud computing network or cloud in communication with a mesh network of IoT devices or IoT fog, in accordance with various embodiments;

FIG. 5 illustrates an example workload distribution environment associated with one or more computer-assisted or autonomous driving (CA/AD) vehicles, in accordance with various embodiments.

FIG. 6 illustrates an example hosting platform including the one or more CA/AD vehicles of FIG. 5, in accordance with various embodiments.

FIG. 7 illustrates a block diagram view of an example computer-assisted or autonomous driving system, in accordance with various embodiments.

FIG. 8 illustrates an example process for assigning a customer workload to a CA/AD vehicle, in accordance with various embodiments.

FIG. 9 illustrates an example process for receiving and performing a compute task by a CA/AD vehicle, in accordance with various embodiments.

FIG. 10 illustrates an example implementation of a computing platform suitable for practicing various aspects of the present disclosure, according to various embodiments;

FIG. 11 illustrates an example computer system, suitable for use to practice the present disclosure (or aspects thereof), in accordance with various embodiments.

FIG. 12 illustrates an example storage medium with instructions configured to enable a computer-assisted or autonomous driving system to practice the present disclosure, in accordance with various embodiments.

### DETAILED DESCRIPTION

Apparatuses, methods, and systems associated with distributed computing using computing resources in computer-assisted or autonomous vehicles and systems are disclosed herein. In embodiments, an apparatus for performing a compute task may include a communication interface disposed in a computer-assisted or autonomous driving (CA/AD) vehicle. The compute task may be a part of a collection of distributed compute tasks that are assigned to the CA/AD vehicle and other compute apparatuses, in embodiments. An assignment of a distributed compute task by a remote management server (or the apparatus itself) may be based at least in part on resources available to the CA/AD vehicle and to the other computer apparatuses, in embodiments. The CA/AD vehicle may include a processing unit such as a compute engine coupled to the communication interface to receive the compute task and to perform the compute task using, at least in part, the available resources of the CA/AD vehicle, in accordance with various embodiments.

In the description to follow, reference is made to the accompanying drawings, which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although a flowchart may describe the operations as a sequential process, many of the operations may be performed in parallel, concurrently, or simultaneously. In addition, the order of the operations may be re-arranged. A process may be terminated when its operations are completed, but may also have additional steps not included in the figure(s). A process may correspond to a method, a function, a procedure, a subroutine, a subprogram, and the like. When a process corresponds to a function, its termination may correspond to a return of the function to the calling function and/or the main function. Furthermore, a process may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium. A code segment may represent a procedure, a function, a subprogram, a program, a routine, a subroutine, a module, program code, a software package, a class, or any combination of instructions, data structures, program statements, and the like.

As used herein, the term “circuitry” may refer to, be part of, or include an Application Specific Integrated Circuit (ASIC), a Field Programmable Gate Array (FPGA), an electronic circuit, a processor (shared, dedicated, or group), a graphics processing unit (GPU), and/or memory (shared, dedicated, or group) that execute one or more software or firmware programs having machine instructions (generated from assembler instructions or compiled from higher level language instructions), a combinational logic circuit, and/or other suitable components that provide the described functionality. As used herein, the term “module” may include logic (including operating systems or application instructions, data, etc.) at least partially operable in circuitry. The circuitry may implement the module to cause the module to perform operations described herein. As used herein, the term “memory” may represent one or more hardware devices for storing data, including random access memory (RAM), magnetic RAM, core memory, read only memory (ROM), magnetic disk storage mediums, optical storage mediums, flash memory devices and/or other machine readable mediums for storing data. The term “computer-readable medium” may include, but is not limited to, memory, portable or fixed storage devices, optical storage devices, wireless channels, and various other mediums capable of storing, containing or carrying instruction(s) and/or data.

As used herein, the term “computer device” may describe any physical hardware device capable of sequentially and automatically carrying out a sequence of arithmetic or logical operations, equipped to record/store data on a machine readable medium, and transmit and receive data from one or more other devices in a communications network. A computer device may be considered synonymous to, and may hereafter be occasionally referred to, as a computer, computing platform, computing device, etc. The term “computer system” may include any type interconnected electronic devices, computer devices, or components thereof, such as cellular phones or smart phones, tablet personal computers, wearable computing devices, an autonomous sensors, laptop computers, desktop personal computers, video game consoles, digital media players, handheld messaging devices, personal data assistants, an electronic book readers, augmented reality devices, Universal Serial Bus (USB) hubs, Keyboard Video Mouse (KVM) switches/hubs, docking stations, port replicators, server computer devices (e.g., stand-alone, rack-mounted, blade, etc.), cloud computing services/systems, network elements, and/or any other like electronic devices. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

As used herein, the term “network element” may refer to one or more computer devices or one or more electronic devices that provide (or provide access to) one or more wired or wireless networks. A “network element” may be considered synonymous to and/or referred to as a networked computer, networking hardware, network equipment, access point, router, switch, hub, bridge, gateway, base station, core network element, server, and/or other like device. The term “network element” may describe equipment that provides radio baseband functions for data and/or voice connectivity between a network element and one or more users.

As used herein, the term “computing resource”, “hardware resource”, “resource”, etc., may refer to a physical or virtual device, a physical or virtual component within a computing environment, and/or physical or virtual component within a particular device, such as computer devices, mechanical devices, memory space, processor/CPU time and/or processor/CPU usage, hardware time or usage, electrical power, input/output operations, ports or network sockets, channel/link allocation, throughput, and/or the like. As used herein, the term “network resource” may refer to computing resources that are accessible by computer devices via a communications network.

The internet of things (IoT) is a concept in which a large number of computing devices are interconnected to each other and to the Internet to provide functionality and data acquisition, sometimes, at low levels. As used herein, however, an IoT device may include a semiautonomous or autonomous device performing a function, such as a CA/AD vehicle and/or a CA/AD system that is integrated into and/or otherwise supports the CA/AD vehicle and including to perform sensing or control, among other functions, in communication with other IoT devices and a wider network, such as the Internet. Sometimes, IoT devices are limited in memory, size, or functionality, allowing larger numbers to be deployed for a similar cost to smaller numbers of larger devices. However, an IoT device may be a smart phone, laptop, tablet, or PC, or other larger device, such as a CA/AD vehicle as noted above. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

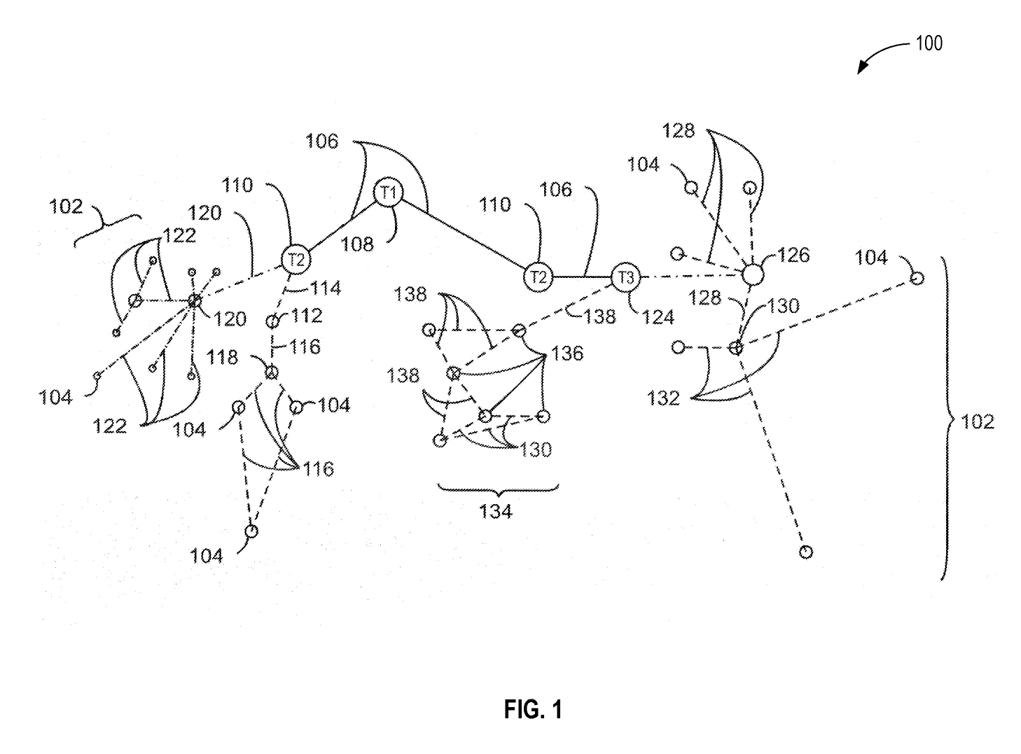

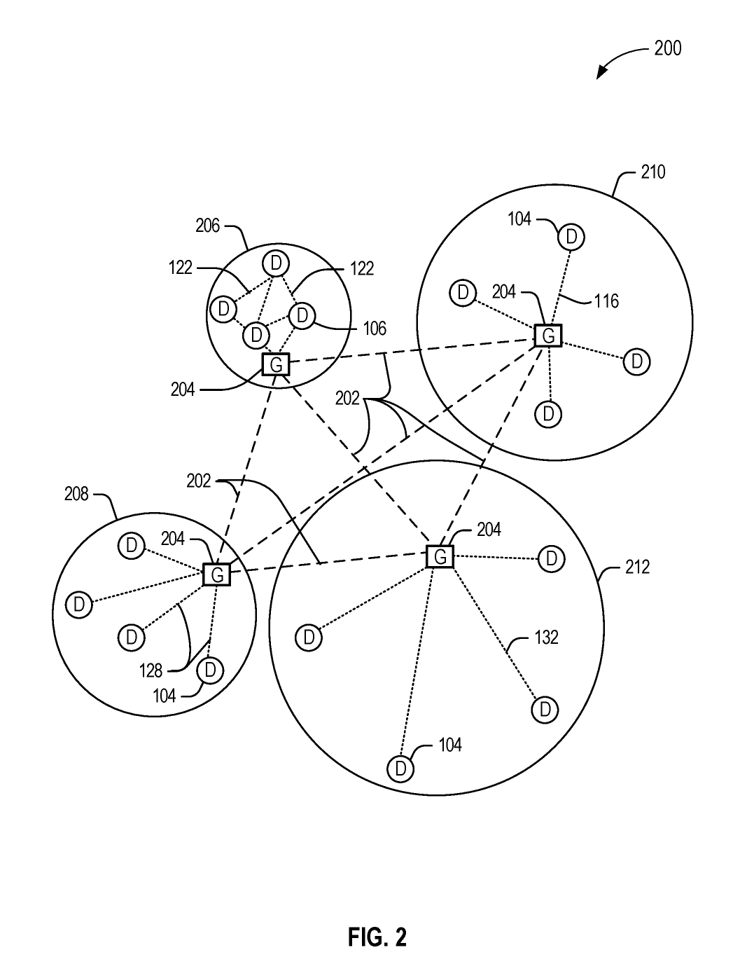

The future growth of the Internet may include very large numbers of IoT devices. Accordingly, as described herein, a number of innovations for the future Internet address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software. The services may be provided in accordance with the Quality of Service (QoS) terms specified in service level and service delivery agreements. The use of IoT devices and networks present a number of new challenges in a heterogeneous network of connectivity comprising a combination of wired and wireless technologies as depicted in FIGS. 1 and 2.

FIG. 1 is a simplified drawing showing interconnections that may be present between the Internet 100 and IoT networks, in accordance with various embodiments. The interconnections may couple smaller networks 102, down to the individual IoT device 104, to the fiber backbone 106 of the Internet 100. To simplify the drawing, not every device 104, or other object, is labeled.

In FIG. 1, top-level providers, which may be termed tier 1 providers 108, are coupled by the fiber backbone of the Internet to other providers, such as secondary or tier 2 providers 110. In one example, a tier 2 provider 110 may couple to a tower 112 of an LTE cellular network, for example, by further fiber links, by microwave communications 114, or by other communications technologies. The tower 112 may couple to a mesh network including IoT devices 104 through an LTE communication link 116, for example, through a central node 118. The communications between the individual IoT devices 104 may also be based on LTE communication links 116. In another example, a high-speed uplink 120 may couple a tier 2 provider 110 to a gateway (GW) 120. A number of IoT devices 104 may communicate with the GW 120, and with each other through the GW 120, for example, over BLE links 122.

The fiber backbone 106 may couple lower levels of service providers to the Internet, such as tier 3 providers 124. A tier 3 provider 124 may be considered a general Internet service provider (ISP), for example, purchasing access to the fiber backbone 110 from a tier 2 provider 110 and providing access to a corporate GW 126 and other customers. From the corporate GW 126, a wireless local area network (WLAN) can be used to communicate with IoT devices 104 through Wi-Fi® links 128. A Wi-Fi link 128 may also be used to couple to a low power wide area (LPWA) GW 130, which can communicate with IoT devices 104 over LPWA links 132, for example, compatible with the LoRaWan specification promulgated by the LoRa alliance.

The tier 3 provider 124 may also provide access to a mesh network 134 through a coordinator device 136 that communicates with the tier 3 provider 124 using any number of communications links, such as an LTE cellular link, an LPWA link, or a link 138 based on the IEEE 802.15.4 standard, such as Zigbee®. Other coordinator devices 136 may provide a chain of links that forms cluster tree of linked devices.

IoT devices 104 may be any object, device, sensor, or “thing” that is embedded with hardware and/or software components that enable the object, device, sensor, or “thing” capable of capturing and/or recording data associated with an event, and capable of communicating such data with one or more other devices over a network with little or no user intervention. For instance, in various embodiments, IoT devices 104 may be abiotic devices such as autonomous sensors, gauges, meters, image capture devices, microphones, machine-type communications (MTC) devices, machine-to-machine (M2M) devices, light emitting devices, audio emitting devices, audio and/or video playback devices, electro-mechanical devices (e.g., switch, actuator, etc.), and the like. In some embodiments, IoT devices 104 may be biotic devices such as monitoring implants, biosensors, biochips, and the like. In other embodiments, an IoT device 104 may be a computer device that is embedded in a computer system and coupled with communications circuitry of the computer system. In such embodiments, the IoT device 104 may be a system on chip (SoC), a universal integrated circuitry card (UICC), an embedded UICC (eUICC), and the like, and the computer system may be a mobile station (e.g., a smartphone) or user equipment, laptop PC, wearable device (e.g., a smart watch, fitness tracker, etc.), “smart” appliance (e.g., a television, refrigerator, a security system, etc.), and the like.

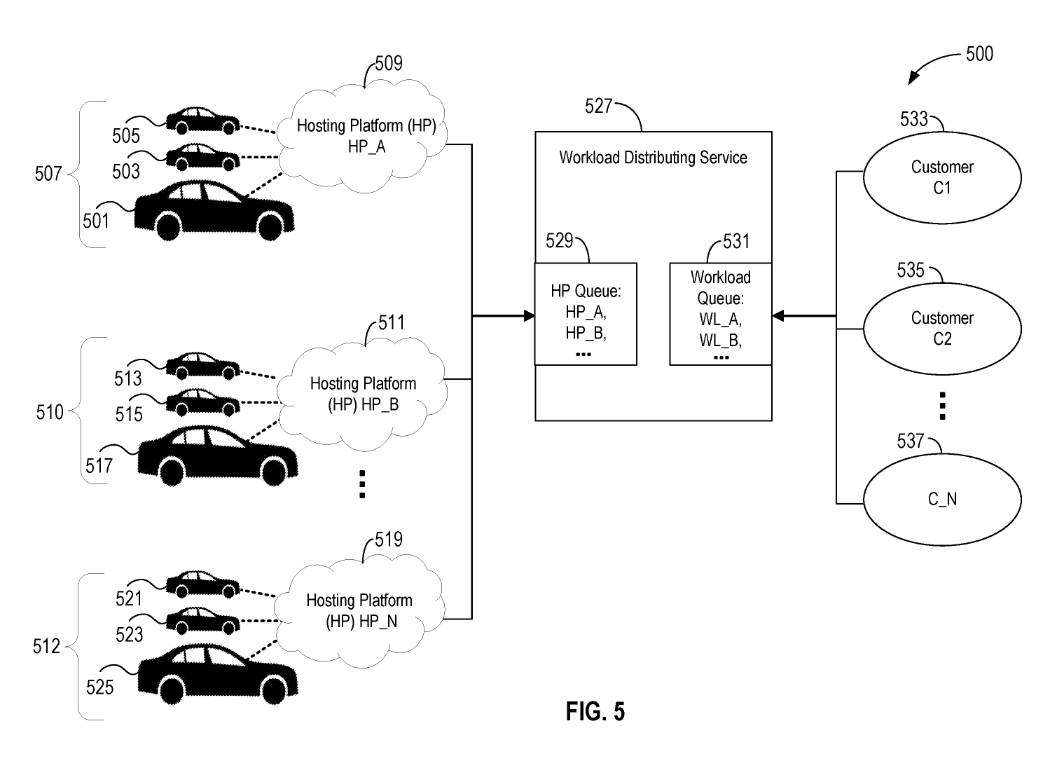

Each of the IoT devices 104 may include one or more memory devices and one or more processors to capture and store/record data. Each of the IoT devices 104 may include appropriate communications circuitry (e.g., transceiver(s), modem, antenna elements, etc.) to communicate (e.g., transmit and receive) captured and stored/recorded data. Further, each IoT device 104 may include other transceivers for communications using additional protocols and frequencies. According to various embodiments, the IoT devices 104 may be equipped with information (e.g., referred to as “modem profiles” herein) to configure configurable communications circuitry to perform communications in a corresponding communications. This may allow the IoT devices 104 to communicate using multiple wireless communications protocols without requiring an IoT device 104 to include separate hardware communications modules for each wireless communications protocol. The wireless communications protocols may be any suitable set of standardized rules or instructions implemented by the IoT devices 104 to communicate with other devices, including instructions for packetizing/depacketizing data, instructions for modulating/demodulating signals, instructions for implementation of protocols stacks, and the like. For example, IoT devices 104 may include communications circuitry that is configurable to communicate in accordance with one or more person-to-person (P2P) or personal area network (PAN) protocols (e.g., IEEE 802.15.4 based protocols including ZigBee, IPv6 over Low power Wireless Personal Area Networks (6LoWPAN), WirelessHART, MiWi, Thread, etc.; WiFi-direct; Bluetooth/BLE protocols; ANT protocols; Z-Wave; LTE D2D or ProSe; UPnP; and the like); configurable to communicate using one or more LAN and/or WLAN protocols (e.g., Wi-Fi-based protocols or IEEE 802.11 protocols, such as IEEE 802.16 protocols); one or more cellular communications protocols (e.g., LTE/LTE-A, UMTS, GSM, EDGE, Wi-MAX, etc.); and the like. In embodiments, one or more of tower 112, GW 120, 126, and 130, coordinator device 136, and so forth, may also be incorporated with the embodiments described herein, in particular, with references to FIGS. 5-11.

The technologies and networks may enable the exponential growth of devices and networks. As the technologies grow, the network may be developed for self-management, functional evolution, and collaboration, without needing direct human intervention. Thus, the technologies will enable networks to function without centralized controlled systems. The technologies described herein may automate the network management and operation functions beyond current capabilities.

FIG. 2 illustrates an example domain topology 200 that may be used for a number of IoT networks coupled through backbone links 202 to GWs 204, in accordance with various embodiments. Like numbered items are as described with respect to FIG. 1. Further, to simplify the drawing, not every device 104, or communications link 116, 122, 128, or 132 is labeled. The backbone links 202 may include any number of wired or wireless technologies, and may be part of a local area network (LAN), a wide area network (WAN), or the Internet. Similar to FIG. 1, in embodiments, one or more of IoT devices 104, GW 204, and so forth, may be incorporated with embodiments described herein, in particular, with references to FIGS. 5-13.

The network topology 200 may include any number of types of IoT networks, such as a mesh network 206 using BLE links 122. Other IoT networks that may be present include a WLAN network 208, a cellular network 210, and an LPWA network 212. Each of these IoT networks may provide opportunities for new developments, as described herein. For example, communications between IoT devices 104, such as over the backbone links 202, may be protected by a decentralized system for authentication, authorization, and accounting (AAA). In a decentralized AAA system, distributed payment, credit, audit, authorization, and authentication systems may be implemented across interconnected heterogeneous infrastructure. This allows systems and networks to move towards autonomous operations.

In these types of autonomous operations, machines may contract for human resources and negotiate partnerships with other machine networks. This may allow the achievement of mutual objectives and balanced service delivery against outlined, planned service level agreements as well as achieve solutions that provide metering, measurements and traceability and trackability. The creation of new supply chain structures and methods may enable a multitude of services to be created, mined for value, and collapsed without any human involvement.

The IoT networks may be further enhanced by the integration of sensing technologies, such as sound, light, electronic traffic, facial and pattern recognition, smell, vibration, into the autonomous organizations. The integration of sensory systems may allow systematic and autonomous communication and coordination of service delivery against contractual service objectives, orchestration and quality of service (QoS) based swarming and fusion of resources.

The mesh network 206 may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 208 may use systems that perform standards conversion to provide multi-standard connectivity, enabling IoT devices 104 using different protocols to communicate. Further systems may provide seamless interconnectivity across a multi-standard infrastructure comprising visible Internet resources and hidden Internet resources.

Communications in the cellular network 210 may be enhanced by systems that offload data, extend communications to more remote devices, or both. The LPWA network 212 may include systems that perform non-Internet protocol (IP) to IP interconnections, addressing, and routing.

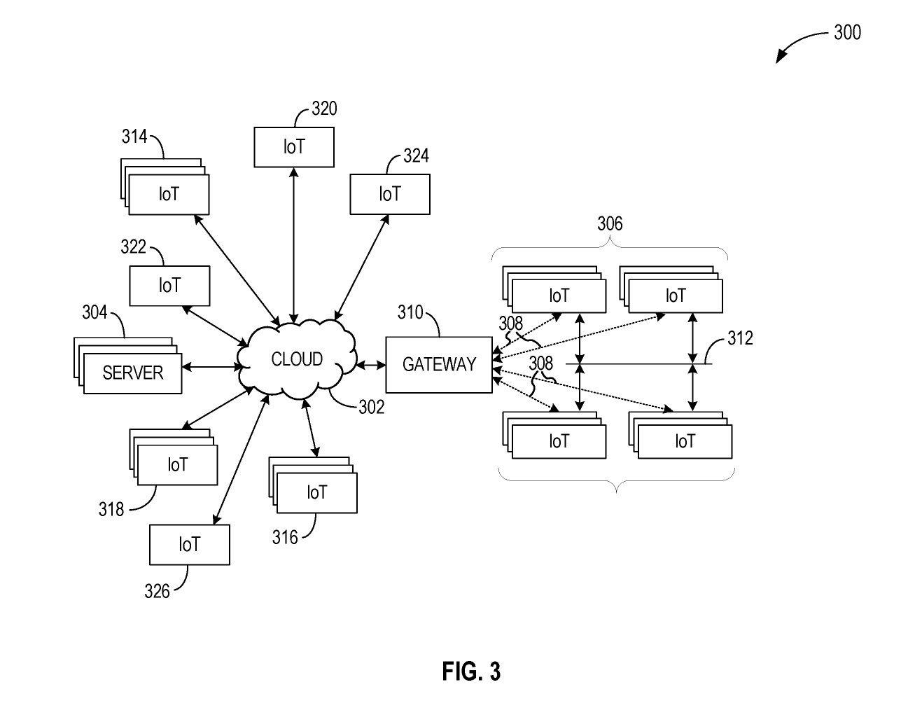

FIG. 3 illustrates an example cloud computing network, or cloud 302, in communication with a number of Internet of Things (IoT) devices, in accordance with various embodiments. In embodiments, the IoT devices may include one or more computer-assisted or autonomous driving (CA/AD) systems or vehicles. The cloud 302 may represent the Internet, one or more cellular networks, a local area network (LAN) or a wide area network (WAN) including proprietary and/or enterprise networks for a company or organization, or combinations thereof. Components used for such communications system can depend at least in part upon the type of network and/or environment selected. Protocols and components for communicating via such networks are well known and will not be discussed herein in detail. However, it should be appreciated that cloud 302 may be associated with network operator who owns or controls equipment and other elements necessary to provide network-related services, such as one or more base stations or access points, and one or more servers for routing digital data or telephone calls (for example, a core network or backbone network).

The IoT devices in FIG. 3 may be the same or similar to the IoT devices 104 discussed with regard to FIGS. 1-2. The IoT devices may include any number of different types of devices, grouped in various combinations, such as IoT group 306 that may include IoT devices that provide one or more services for a particular user, customer, organizations, etc. A service provider may deploy the IoT devices in the IoT group 306 to a particular area (e.g., a geolocation, building, etc.) in order to provide the one or more services. In one example, the IoT group 306 may be a traffic control group where the IoT devices in the IoT group 306 may include stoplights, traffic flow monitors, cameras, weather sensors, and the like, to provide traffic control and traffic analytics services for a particular municipality or other like entity. Similar to FIGS. 1-2, in embodiments, one or more of IoT devices 314-324, GW 310, and so forth, may be incorporated with the various embodiments described herein, in particular, with references to FIGS. 5-9. For example, in some embodiments, the IoT group 306, or any of the IoT groups discussed herein, may include a hosting platform including one or more computer-assisted or autonomous driving (CA/AD) vehicles and/or workload distributing service discussed infra with regard to FIGS. 5-9.

The IoT group 306, or other subgroups, may be in communication with the cloud 302 through wireless links 308, such as LPWA links, and the like. Further, a wired or wireless sub-network 312 may allow the IoT devices to communicate with each other, such as through a local area network, a wireless local area network, and the like. The IoT devices may use another device, such as a GW 310 to communicate with the cloud 302. Other groups of IoT devices may include remote weather stations 314, local information terminals 316, alarm systems 318, automated teller machines 320, alarm panels 322, or moving vehicles, such as emergency vehicles 324 or other vehicles 326, among many others. Each of these IoT devices may be in communication with other IoT devices, with servers 304, or both.

As can be seen from FIG. 3, a large number of IoT devices may be communicating through the cloud 302. This may allow different IoT devices to request or provide information to other devices autonomously. For example, the IoT group 306 may request a current weather forecast from a group of remote weather stations 314, which may provide the forecast without human intervention. Further, an emergency vehicle 324 may be alerted by an automated teller machine 320 that a burglary is in progress. As the emergency vehicle 324 proceeds towards the automated teller machine 320, it may access the traffic control group 306 to request clearance to the location, for example, by lights turning red to block cross traffic at an intersection in sufficient time for the emergency vehicle 324 to have unimpeded access to the intersection.

In another example, the IoT group 306 may be an industrial control group (also referred to as a “connected factory”, an “industry 4.0” group, and the like) where the IoT devices in the IoT group 306 may include machines or appliances with embedded IoT devices, radiofrequency identification (RFID) readers, cameras, client computer devices within a manufacturing plant, and the like, to provide production control, self-optimized or decentralized task management services, analytics services, etc. for a particular manufacturer or factory operator. In this example, the IoT group 306 may communicate with the servers 304 via GW 310 and cloud 302 to provide captured data, which may be used to provide performance monitoring and analytics to the manufacturer or factory operator. Additionally, the IoT devices in the IoT group 306 may communicate among each other, and/or with other IoT devices of other IoT groups, to make decisions on their own and to perform their tasks as autonomously as possible.

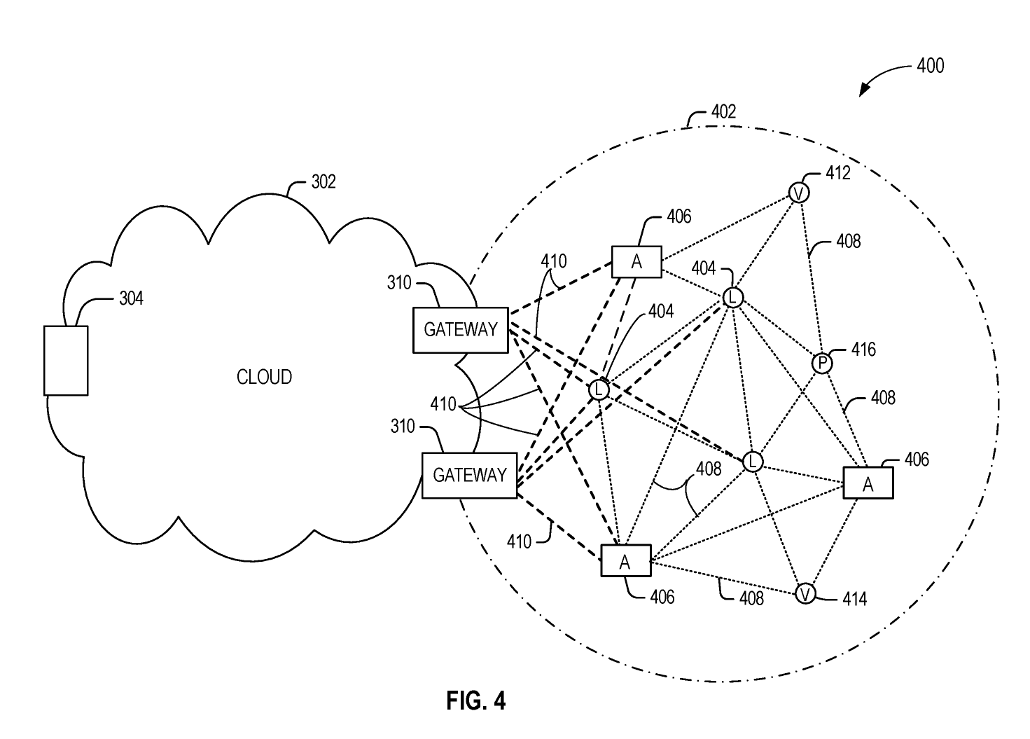

Clusters of IoT devices, such as the IoT groups depicted by FIG. 3, may be equipped to communicate with other IoT devices as well as with the cloud 302. This may allow the IoT devices to form an ad-hoc network between the devices, allowing them to function as a single device, which may be termed a fog device. This is discussed further with respect to FIG. 4.

FIG. 4 illustrates an arrangement 400 of a cloud computing network, or cloud 302, in communication with a mesh network of IoT devices, which may be termed a fog device 402, operating at the edge of the cloud 302, in accordance with various embodiments. Like numbered items are as described with respect to FIGS. 1-3. In this example, the fog device 402 is a group of IoT devices at an intersection. The fog device 402 may be established in accordance with specifications released by the OpenFog Consortium (OFC), the Open Connectivity Foundation™ (OCF), among others.

Data may be captured, stored/recorded, and communicated among the IoT devices 404. Analysis of the traffic flow and control schemes may be implemented by aggregators 406 that are in communication with the IoT devices 404 and each other through a mesh network. Data may be uploaded to the cloud 302, and commands received from the cloud 302, through GWs 310 that are in communication with the IoT devices 404 and the aggregators 406 through the mesh network. Similar to FIGS. 1-3, in embodiments, one or more of IoT devices 404, aggregators 406, and so forth, may be incorporated with the various embodiments described herein, in particular, with references to FIGS. 5-9. For example, in some embodiments, the fog device 402, or any of grouping of devices discussed herein, may include the CA/AD vehicle(s) or CA/AD systems, remote workload distributing server, and/or one or more devices discussed infra with regard to FIGS. 5-9.

Any number of communications links may be used in the fog device 402. Shorter-range links 408, for example, compatible with IEEE 802.15.4 may provide local communications between IoT devices that are proximate to one another or other devices. Longer-range links 410, for example, compatible with LPWA standards, may provide communications between the IoT devices and the GWs 310. To simplify the diagram, not every communications link 408 or 410 is labeled with a reference number.

The fog device 402 may be considered to be a massively interconnected network wherein a number of IoT devices are in communications with each other, for example, by the communication links 408 and 410. The network may be established using the open interconnect consortium (OIC) standard specification 1.0 released by the Open Connectivity Foundation™ (OCF) on Dec. 23, 2015. This standard allows devices to discover each other and establish communications for interconnects. Other interconnection protocols may also be used, including, for example, the AllJoyn protocol from the AllSeen alliance, the optimized link state routing (OLSR) Protocol, or the better approach to mobile ad-hoc networking (B.A.T.M.A.N), among many others.

Communications from any IoT device may be passed along the most convenient path between any of the IoT devices to reach the GWs 310. In these networks, the number of interconnections may provide substantial redundancy, allowing communications to be maintained, even with the loss of a number of IoT devices.

Not all of the IoT devices may be permanent members of the fog device 402. In the example in the drawing 400, three transient IoT devices have joined the fog device 402, a first mobile device 412, a second mobile device 414, and a third mobile device 416. The fog device 402 may be presented to clients in the cloud 302, such as the server 304, as a single device located at the edge of the cloud 302. In this example, the control communications to specific resources in the fog device 402 may occur without identifying any specific IoT device 404 within the fog device 402. Accordingly, if any IoT device 404 fails, other IoT devices 404 may be able to discover and control a resource. For example, the IoT devices 404 may be wired so as to allow any one of the IoT devices 404 to control measurements, inputs, outputs, etc., for the other IoT devices 404. The aggregators 406 may also provide redundancy in the control of the IoT devices 404 and other functions of the fog device 402.

In some examples, the IoT devices may be configured using an imperative programming style, e.g., with each IoT device having a specific function and communication partners. However, the IoT devices forming the fog device 402 may be configured in a declarative programming style, allowing the IoT devices to reconfigure their operations and communications, such as to determine needed resources in response to conditions, queries, and device failures. This may be performed as transient IoT devices, such as the devices 412, 414, 416, join the fog device 402. As transient or mobile IoT devices enter or leave the fog 402, the fog device 402 may reconfigure itself to include those devices. This may be performed by forming a temporary group of the devices 412 and 414 and the third mobile device 416 to control or otherwise communicate with the IoT devices 404. If one or both of the devices 412, 414 are autonomous, the temporary group may provide instructions to the devices 412, 414. As the transient devices 412, 414, and 416, leave the vicinity of the fog device 402, it may reconfigure itself to eliminate those IoT devices from the network. The fog device 402 may also divide itself into functional units, such as the IoT devices 404 and other IoT devices proximate to a particular area or geographic feature, or other IoT devices that perform a particular function. This type of combination may enable the formation of larger IoT constructs using resources from the fog device 402.

As illustrated by the fog device 402, the organic evolution of IoT networks is central to maximizing the utility, availability and resiliency of IoT implementations. Further, the example indicates the usefulness of strategies for improving trust and therefore security. The local identification of devices may be important in implementations, as the decentralization of identity ensures a central authority cannot be exploited to allow impersonation of objects that may exist within the IoT networks. Further, local identification lowers communication overhead and latency.

Referring now to FIG. 5, which illustrates an example workload distribution environment 500 associated with one or more computer-assisted or autonomous driving (CA/AD) vehicles (hereinafter “vehicle(s)”), in embodiments. A plurality of hosting platforms 509, 511, and 519, may be coupled to a workload outsourcing or workload distributing service 527, which may be in turn be communicatively coupled to customers C1 533, C2 535, and C_N 537, for the embodiment. Each of hosting platforms 509, 511, and 519 may be associated with a respective set of one or more vehicles, in accordance with various embodiments. As shown, for the embodiment, example hosting platform 509 may be associated with a plurality of vehicles 507 that may include vehicles 501, 503, and 505. Accordingly, for the embodiment, additional hosting platform 511 may be associated with plurality of vehicles 510 that may include vehicles 513, 515, and 517. Furthermore, in the embodiments, additional hosting platform 519 may include plurality of vehicles 512 including vehicles 521, 523, and 525.

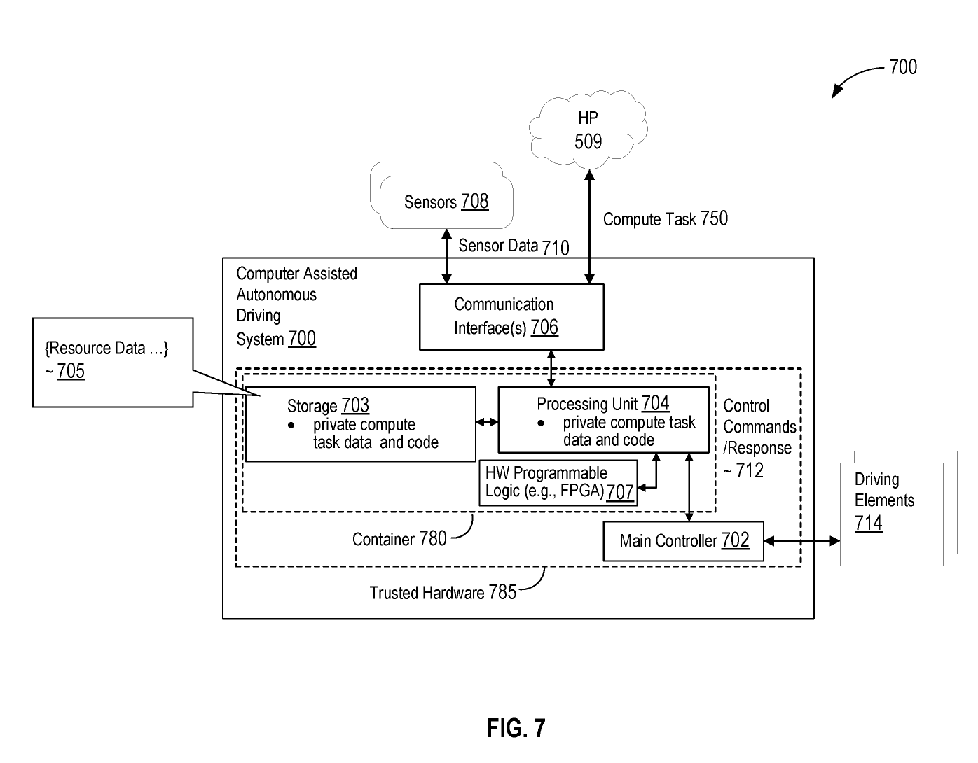

In embodiments, a computer-assisted or autonomous (CA/AD) driving system (illustrated in more detail with respect to FIG. 7) may be disposed in one or more of the vehicles. In embodiments, the CA/AD driving system may receive a compute task. In embodiments, the compute task may be part of a collection of distributed compute tasks that may be assigned to the CA/AD driving system based in part on resources available to the associated vehicle and to other computer apparatuses, which may include other CA/AD vehicles. As shown, in embodiments, workload distributing service 527 may assign the distributed compute task to, e.g., vehicle 501. In embodiments, workload distributing service 527 may receive a customer workload request from one or more customers, e.g., C1 533, C2 535, and/or C_N 537. In embodiments, workloads may include, but are not limited to, compute jobs related to computationally intensive tasks such as, e.g., executing a resource-demanding algorithm and/or processing large volumes of data from customers such as industry, the scientific community, and/or individuals. A workload may include any suitable compute job or task that may be appropriate for a hosting platform to perform. For example, workloads may range from handling transactions from retail websites during high-demand periods of time to Bitcoin or ETHEREUM® node applications, and/or to applications related to video gaming. In some embodiments, a workload and its requirements may be specified in a Service Level Agreement (SLA). In embodiments, the SLA may describe specific requirements for the compute job as well as security standards (e.g., encrypting all stored and transmitted data), performance (e.g., response times), ownership of data, and the like. In addition to fulfilling parameters and descriptions (e.g., processing the data in accordance with an algorithm and/or the like, for a specific job), the workload may include observing, monitoring, and tracking other requirements of the SLA as noted above (the meeting of security standards and the like).

Accordingly, in embodiments, workload distributing service 527 may assign a customer workload to one or more of the hosting platforms 509, 511, and 519 based at least in part on resources of vehicles associated with the assigned platform. In embodiments, the resources may include any suitable resources available to one or more of the vehicles. In various embodiments, resources may include, but not be limited to, computational power, storage (and/or partitionable storage), availability of trusted hardware and/or software, network connectivity, a predictable location, sensors of the vehicle, and energy available to one or more of the vehicles. In embodiments, resource information may also include or be accompanied by historical information associated with the vehicle to allow prediction of availability of the resources. In embodiments, historical information may be received from the at least one other CA/AD vehicle and analyzed to predict an availability of the resources of the at least one other CA/AD vehicles to assist in pairing the CA/AD vehicles to jointly perform the compute tasks.

In embodiments, workload distributing service 527 may reside on one or more servers in the Cloud. In embodiments, a workload assigned to a hosting platform may be a standalone workload. In embodiments, a workload assigned to a hosting platform may be a portion of a larger workload, where the other portions may be assigned to other hosting platforms or being performed on other servers in the Cloud.

Accordingly, in embodiments, workload distributing service 527 may determine and manage a hosting platform queue 529 and a workload queue 531 to match resources of hosting platforms, e.g., 509, 511, and/or 519 with needs of workloads associated with workload requests by one or more of customers C1 533, C2 535, and/or C_N 537. Note that for purposes of clarity in the FIG. 5, each hosting platform includes three vehicles, however, embodiments may include any suitable number of vehicles that may from a plurality to provide services for the purposes described herein. Furthermore, in embodiments, there may be any suitable number of hosting platforms (e.g., HP N) to accommodate available vehicles and/or permutations of available vehicles to correspond to workload requests.

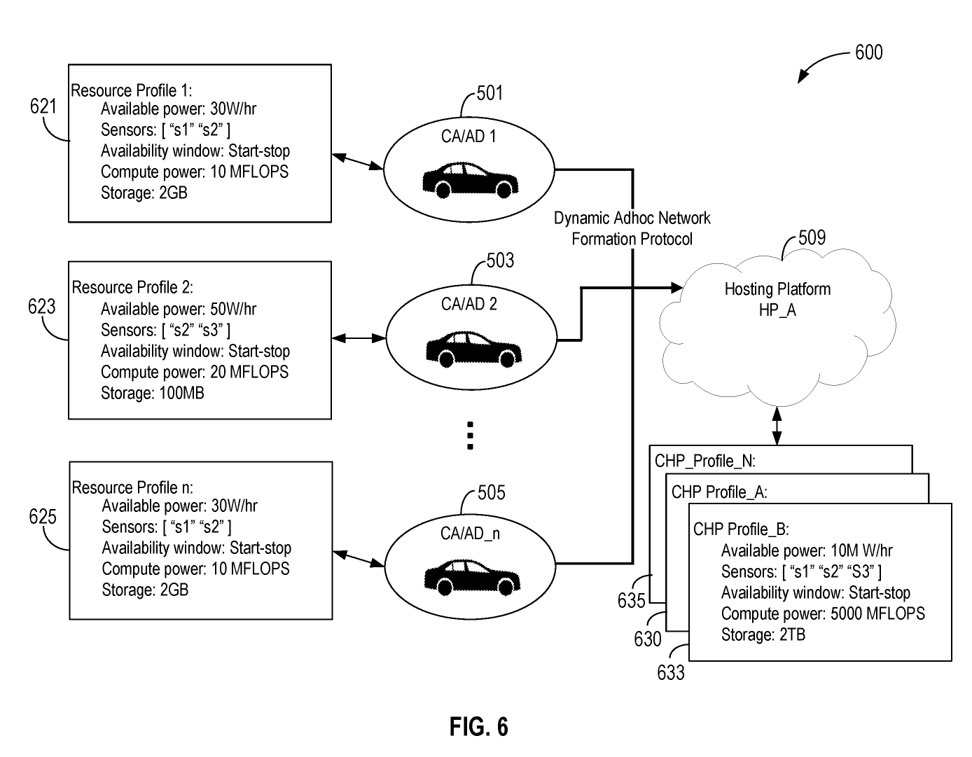

FIG. 6 illustrates in more detail, hosting platform 509 including CA/AD vehicles 501, 503, and 505, in accordance with various embodiments. In embodiments, vehicles 501, 503, and 505, may each be associated with respective example vehicle resource profiles 621, 623, and 625. For example, as illustrated for the embodiment, vehicle resource profile 621 for vehicle 501 may indicate available power of 30 Watts/hour (30 W/hr), sensor types “s1” and “s2”, an availability window for the resources (e.g., start-stop time of vehicle indicating when vehicle is parked and resources are potentially available), compute power of 10 megaflops, and storage of 2 GB. Note that sensor types may be associated with, but not limited to, any suitable sensor devices that may provide, for example, camera data, RADAR data, light detection and ranging (LIDAR) data, radiation temperature data, or Global Positioning System (GPS) data, in embodiments. As illustrated in FIG. 6, for the embodiments, vehicle resource profiles 623 and 625 list various example resources associated with vehicle 503 and 505. As noted above, in embodiments, vehicle 505 is indicative of CA/AD . . . n, as any suitable number of vehicles to perform a client workload may be included in example hosting platform 509.

Note that in embodiments, resources of the vehicles may be available when one or more of the vehicles is parked. In embodiments, vehicle 501 may be instructed, or determine on its own, to form a network with vehicles 503 and 505, based at least in part on a predictable physical proximity to the other vehicles 503 and 505, likelihood to be assigned a similar workload, physical proximity to a high bandwidth network (e.g. a 5G antenna located on or near a proximal parking garage or lot). For example, as illustrated, vehicles 501, 503, and 505 may form a network using a network formation protocol, e.g., dynamic adhoc network formation (DANF) protocol.

In embodiments, workload distributing service 527 (of FIG. 5) may receive a customer workload request from one or more customers. In embodiments, workload distributing service 527 may also receive, a plurality of resource profiles corresponding to a plurality of hosting platforms each including a plurality of CA/AD vehicles. In embodiments, a computing entity such as a remote server or one or more CA/AD systems or driving system(s) may amalgamate one or more collective hosting profiles to correspond with each of a corresponding plurality of CA/AD vehicles, e.g., 507, 510, and 512 of FIG. 5. Additionally, as shown in FIG. 6, in embodiments, the computing entity may create one or more collective hosting profiles 630, 633, and/or 635, associated with single hosting platform 509, based at least in part on vehicle resource profiles, e.g., 621, 623, and 625. Accordingly, in embodiments, various collective hosting profiles 630, 633, and/or 635 may include a combination of resources from one or more of the individual vehicle resource profiles 621, 623, and 625 that may match a variety of workloads. In various embodiments, the computing entity may partition resources of the vehicles, e.g., storage, in a manner to allow a platform support a plurality of workloads.

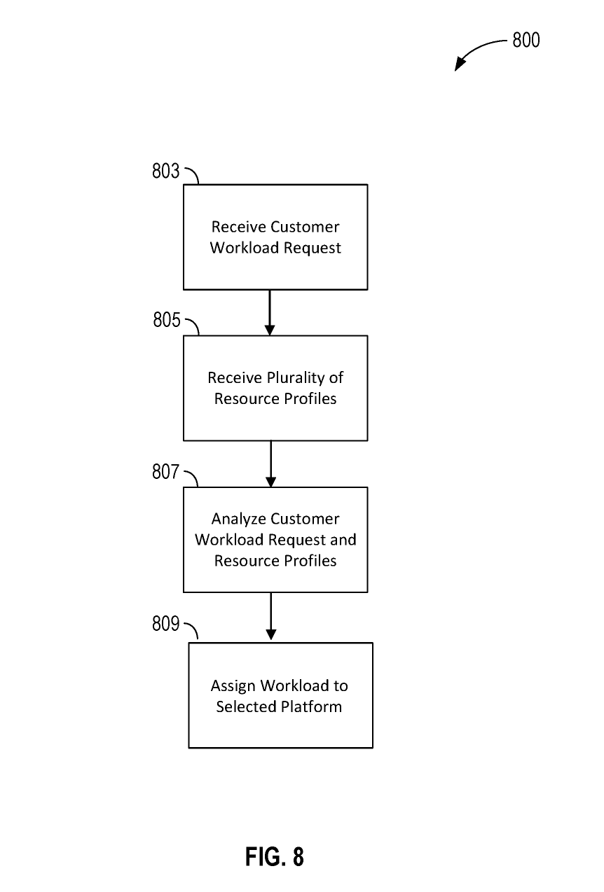

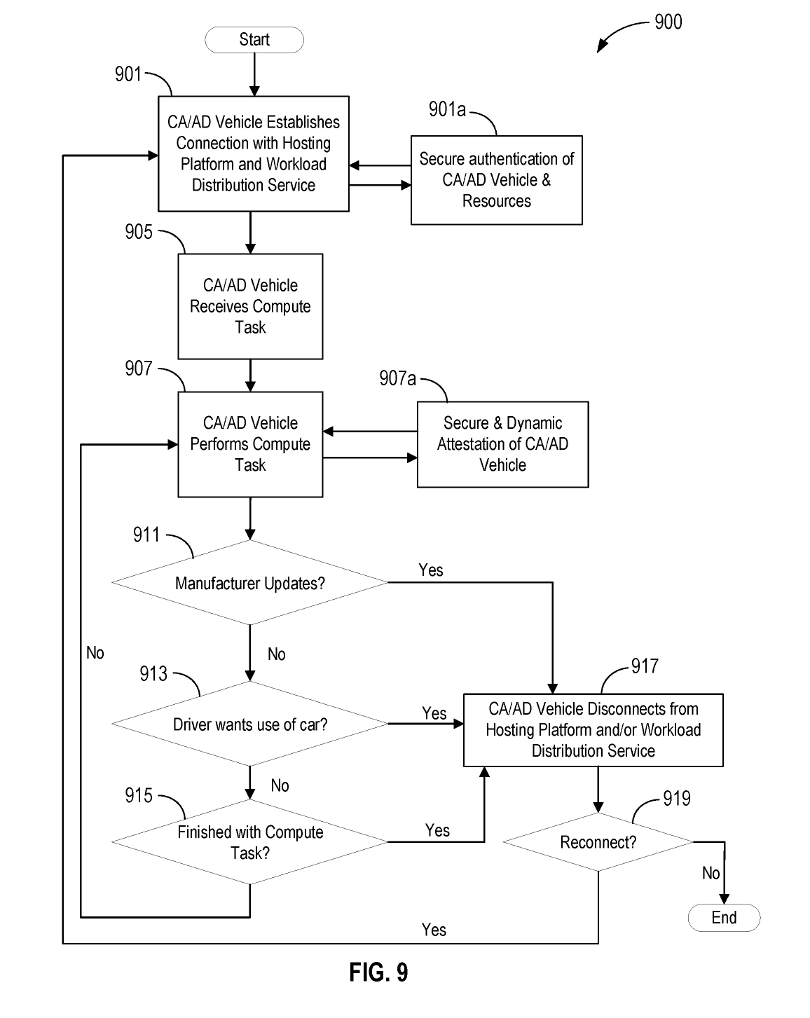

Furthermore, in embodiments, additional compute entities other than vehicles may be included in the resource profiles or may be considered when matching workloads to hosting platforms or vehicles. In various embodiments, in order to isolate a “normal” workload from the compute task, attestation and secure enclave or container technology may be utilized (discussed below with respect to FIGS. 8 and 9). In embodiments, a plurality of workloads may correspond to a plurality of containers, each container encapsulating a corresponding workload. Furthermore, operations and storage may be isolated within containers within a vehicle and/or computing entity. In various embodiments, users of vehicles, e.g., 501, 503, and 505 may be compensated for use of their vehicle in performing work. Note that in various embodiments, each of the vehicles may comprise a blockchain processing node. In some embodiments, each vehicle associated with a hosting platform may assist in amalgamating and maintaining a collective hosting profile based at least in part on resource profiles of individual vehicles of the plurality. In various other similar embodiments, each vehicle may form a blockchain processing node for purposes of performing an assigned workload from a customer, e.g., performing work as an Ethereum or other node. Accordingly, one or more hosting platforms 509, 511, or 519 may be located in a cloud 302 or distributed among the vehicles 501, 503, and 505.

Referring now to FIG. 7, where a block diagram view of an example computer-assisted autonomous driving system (CA/AD) system, in accordance with various embodiments, is shown. As illustrated, CA/AD system 700 may include one or more communication interfaces 706, a compute engine or processing unit 704, storage 703, and main controller 702 coupled with each other as shown. In embodiments, main controller 702 may be configured to issue control commands 712 to driving elements 714 of a CA/AD vehicle, e.g. vehicle 501 (e.g., an engine, electric motor, braking system, drive system, wheels, transmission, and a battery and so forth). In embodiments, trusted hardware 785 may include a secure enclave or container 780 that may include a memory and/or storage 703 to isolate private compute data and compute code associated with a received compute task. In embodiments, processing unit 704 may execute private compute code associated with the compute task within container 780. In embodiments, processing unit 704 may be a processor equipped to protect confidentiality of a computation by isolating the private code and data including from an operating system and devices coupled to the system bus, e.g., an Intel® processor with Software Guard Extensions (SGX)® support.

In embodiments, the compute task may be received via example hosting platform 509. In embodiments, one of the one or more communication interfaces 706 may be configured to receive compute task 750 from a workload outsourcing service, e.g. workload distributing service 527. One or more communication interfaces 706 may also be configured to receive various sensor data 710 from sensors 708 for the embodiment. In embodiments, sensor data 710 may comprise camera data, radiation temperature data, or GPS data, e.g., camera data, radiation temperature data, or GPS data collected respectively by a camera, a radiation temperature sensor or a GPS sensor 208, disposed in CA/AD vehicle 501. In embodiments, one or more communication interfaces 706 may be configured to transmit information to the hosting platform or workload outsourcing service. In embodiments, the information may include information related to the compute task (including work completed or partially completed) and/or resource data including sensor data 710. In embodiments, the information may include data such as resource data 705 including historical data stored in secure storage 703. The owner, the driver and/or the passenger may be temporarily away from the parked CA/AD vehicle 501 during performance of the compute task. In embodiments, information related to payment for entirety or a portion of the compute task that is completed may be received from the hosting platform or workload distribution service for an owner of the CA/AD vehicle 501 by communication interface 706.

In embodiments, one or more communication interfaces 706 may include a communication interface, such as a I² bus, an Integrated Drive Electronic (IDE) bus, a Serial Advanced Technology Attachment (SATA) bus, a Peripheral Component Interconnect (PCI) bus, a Universal Serial Bus (USB), a Near Field Communication (NFC) interface, a Bluetooth® interface, WiFi, and so forth, for receiving sensor data 710 from sensors 708. In embodiments, processing unit 704 may be configured to receive sensor data 710 of the environmental condition of the area around or adjacent to the CA/AD vehicle, via communication interface(s) 706, while CA/AD vehicle is parked. Further, processing unit 704 may be configured to analyze, continuously or periodically, sensor data 710, to collect the historical data (as noted above) related to resource availability (e.g., times when the CA/AD vehicle is parked, routes, energy availability, and the like).

In embodiments, processing unit 704 may be implemented in hardware, e.g., ASIC, or programmable combinational logic circuit (e.g., (FPGA)), or software (to be executed by a processor and memory arrangement), or combination thereof. As noted below in connection with FIG. 9, a hardware accelerator or hardware programmable logic 707 (e.g., FPGA) may be programmable to accommodate various needs of various customer workloads. In various embodiments, processing unit 704 and/or secure storage 703 may operate/accessed in a separate trusted/secured execution environment, separate, isolated and protected from the general execution environment for applications related to the autonomous vehicle operations and access by the driver. In embodiments, workload-related processing and storage may be implemented in secure enclaves.

Referring now to FIG. 8, wherein an example process for assigning a customer workload to a CA/AD vehicle is shown, in accordance with various embodiments. As illustrated, process 800 may include operations performed in blocks 803-809. The operations may be performed by e.g., one or more external or remote workload management server(s) located in a cloud and/or GSM EDGE network (e.g., see FIGS. 1-4) or by CA/AD system 700 of FIG. 7, as part of a trusted arrangement between CA/AD vehicles (e.g., in one embodiment, via a blockchain arrangement). In alternate embodiments, process 800 for assigning the customer workload may include more or less operations, or have some of the operations performed in different order. Process 800 may start at block 803 when a customer workload request may be received (e.g., from a client) or retrieved (from a remote or local request queue), in an embodiment. In embodiments, authentication of identification and/or resources of the CA/AD vehicles may be received via remote attestation (discussed further with respect to FIG. 9 below). For example, in various embodiments, a customer workload request may include or correspond to a service level agreement (SLA). In some embodiments, the SLA may be analyzed to determine what types of resources may be needed to fulfill the agreement or request, e.g., an appropriate amount of available energy, compute power, storage, processing power, sensor type, and the like. For the embodiment, at a next block, 805, a plurality of resource profiles associated with a corresponding plurality of hosting platforms or other aggregation of CA/AD vehicles that may perform work may be received or retrieved (from a remote database or a local cache). In embodiments, a hosting platform may have previously registered one or more resource profiles, based at least in part on collective resources and historical information of a plurality of CA/AD vehicles, to indicate that the plurality is available to receive a workload. In embodiments, further authentication of resources of the CA/AD vehicles may be received via remote attestation (not shown). Accordingly, in embodiments, at next block 807, the customer workload request and resource profiles are analyzed to determine a match based on, e.g., the SLA and resources to fulfill the SLA. Finally, for the embodiment, at a block 809, a customer workload related to the workload request may be assigned to a selected hosting platform based at least in part on the analysis. In embodiments, the assignment, along with information related to the customer workload may then be transmitted to the selected platform including a plurality of CA/AD vehicles. In alternate embodiments, the assignment may be transmitted with location information identifying where the customer workload may be retrieved.

Referring now to FIG. 9, wherein an example process for receiving/retrieving and performing a compute task by a CA/AD vehicle, in accordance with various embodiments, is shown. As illustrated, process 900 may include operations performed in blocks 901-917. In alternate embodiments, process 900 for receiving/retrieving and performing the compute task may include more or less operations, or have some of the operations performed in different order. Process 900 may begin at block 901 where the CA/AD vehicle (“vehicle”) may establish a connection with a hosting platform (e.g., hosting platform 509) and/or workload distributing service (e.g., workload distributing service 527). In embodiments, the vehicle may establish the connection to indicate an availability to perform a compute task by registering the availability with a network of a plurality of other vehicles that are similarly available to perform a workload related to the compute task.

In embodiments, the vehicle may include a CA/AD system that includes hardware and/or software (HW/SW) security. In embodiments, trusted hardware and software of the CA/AD system may provide safe enclaves or containers for containing resources such as storage, RAM, and the like. Accordingly, for the embodiment, secure authentication of the vehicle may occur at block 901a, e.g., via a security authentication server, during or prior to the connection of the vehicle to allow the hosting platform and/or workload distributing service to trust the vehicle. In embodiments, the security authentication server may also assist in providing a secure method of attesting resources and compute capability of the vehicle. In embodiments, the attestation of resources and compute capability may assist in determining an amount and type of compute tasks that may be assigned to the vehicle (e.g., as performed with reference to FIG. 8). In embodiments, the CA/AD system may include a trusted execution environment, e.g., Intel's Software Guard Extensions (SGX)®-based trusted execution environment (TEE) and the secure authentication server may include an SGX® authentication server.

At a next block 905, in embodiments, the vehicle may receive a compute task and/or information related to an associated workload transmitted from the hosting platform and/or workload distributing service. As described earlier, in embodiments, the vehicle may receive the assignment information along with location information indicating where information associated with the compute task may be retrieved. In embodiments, the hosting platform and/or workload distributing service may install applications on the CA/AD system for duration of the performance of the compute. Next, at a block 907, on receipt or retrieval of the compute task (and installation of the necessarily software, the vehicle may perform the compute task. Note that in various embodiments, a hardware accelerator (such as an FPGA) in the CA/AD system may be reprogrammed in real time to optimize or increase compute functionality and based at least in part on an assigned compute task. Furthermore, in embodiments, secure and dynamic attestation of the CA/AD system can be again provided during performance of the compute task. At a next decision block 911, if the vehicle (and/or hosting platform) has received a notification that the manufacturer has software or firmware updates for the vehicle, the vehicle may disconnect from the hosting platform and/or workload distribution service at a block 917. If not, the CA/AD system may continue to perform the compute task, in embodiments. For the embodiment, the process continues to a next block 913, where, if the driver would like use of the vehicle, the vehicle may disconnect at a block 917. Else, in embodiments, the CA/AD system may continue to perform the compute task. In embodiments, if the vehicle has to disconnect from hosting platform at block 917 prior to the compute task being completed, the vehicle may suspend the compute task until the vehicle can resume performing the compute task, transfer the partially completed compute task to other vehicles in the hosting platform to continue, or transfer the partially completed compute task back to the workload distribution service for re-assignment. In embodiments, a transfer may include transfer of the intermediate results or states of the partially completed compute task, prior to disconnecting from the hosting platform and/or workload distribution service.

In embodiments, if the CA/AD system is able continue to perform the compute task until completion, eventually, the answer at block 915 is yes, and the vehicle may disconnect from the hosting platform and/or workload distributing service at block 917. Note that in various embodiments, once the vehicle is disconnected, a previous driving system state may be restored. In embodiments, a trusted execution technology (e.g., TXT technology) which may be modified for dynamic verification may be used to verify the previous driving system state without rebooting the CA/AD system. Note that in embodiments, if the CA/AD system is compromised, the CA/AD system may report the error to the hosting platform and not resume its intended operation until the error may be corrected. In embodiments, after the vehicle is disconnected, the hosting platform and/or workload distributing service may determine an amount of work performed by the CA/AD system in order to compensate the driver or car owner.

In embodiments, after disconnection at block 917, the CA/AD system may determine at a block 919, whether it is appropriate for the CA/AD system to reconnect (e.g., as indicated in settings by the driver or car owner or by a default setting). In embodiments, if the answer is no, the process may end at a next block. If the answer is yes, the process loops back to block 901, where the vehicle may again establish a connection with the hosting platform and/or workload distributing service 527. In embodiments, the vehicle may check to determine if the CA/AD system should continue with a previously unfinished compute task by the vehicle or can indicate to the hosting platform and/or workload distributing service 527 that it is again available to perform a new compute task.

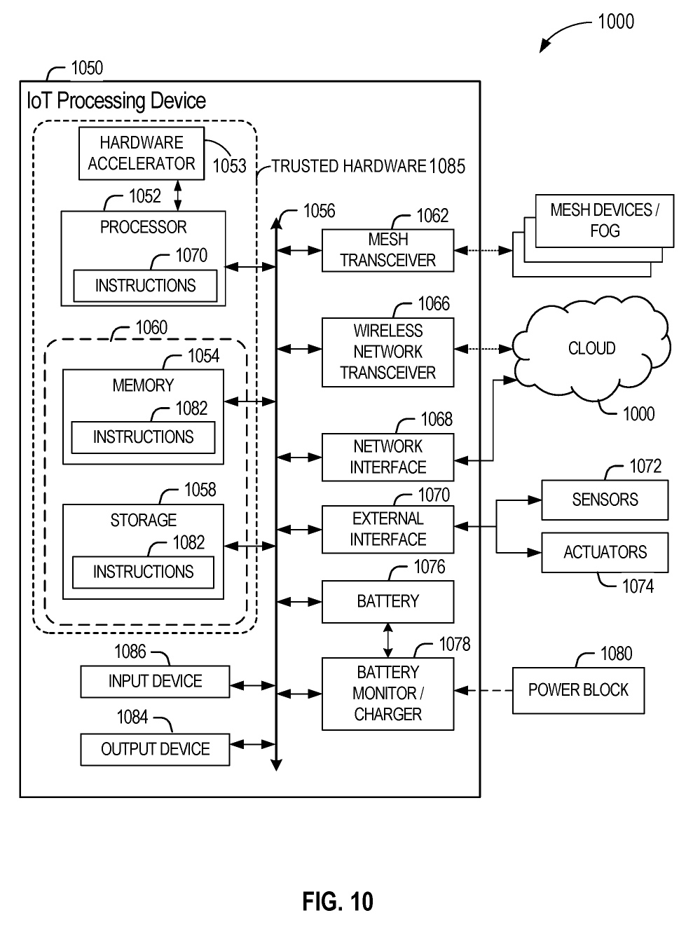

FIG. 10 is a block diagram of an example of components that may be present in an IoT device 1050 for implementing the techniques described herein. The IoT device 1050 may include any combinations of the components shown in the example or referenced in the disclosure above. The components may be implemented as ICs, portions thereof, discrete electronic devices, or other modules, logic, hardware, software, firmware, or a combination thereof adapted in the IoT device 1050, or as components otherwise incorporated within a chassis of a larger system. Additionally, the block diagram of FIG. 10 is intended to depict a high-level view of components of the IoT device 1050. However, some of the components shown may be omitted, additional components may be present, and different arrangement of the components shown may occur in other implementations.

The IoT device 1050 may include trusted hardware 1085 which may include a processor 1052, which may be a microprocessor, a multi-core processor, a multithreaded processor, an ultra-low voltage processor, an embedded processor, or other known processing element. The processor 1052 may be a part of a system on a chip (SoC) in which the processor 1052 and other components are formed into a single integrated circuit, or a single package, such as the Edison™ or Galileo™ SoC boards from Intel. As an example, the processor 1052 may include an Intel® Architecture Core™ based processor, such as a Quark™, an Atom™, an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A10 processor from Apple® Inc., a Snapdragon™ processor from Qualcomm® Technologies, Inc., or an OMAP™ processor from Texas Instruments, Inc. In embodiments, processor 1052 may be coupled to hardware accelerator 1053, which may in some embodiments include, e.g., programmable logic such as a reprogrammable FPGA that may be customized according to a compute task.

The processor 1052 may communicate with a system memory 1054 over an interconnect 1056 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1058 may also couple to the processor 1052 via the interconnect 1056. In an example, the storage 1058 may be implemented via a solid-state disk drive (SSDD). Other devices that may be used for the storage 1058 include flash memory cards, such as SD cards, microSD cards, xD picture cards, and the like, and USB flash drives. In low power implementations, the storage 1058 may be on-die memory or registers associated with the processor 1052. However, in some examples, the storage 1058 may be implemented using a micro hard disk drive (HDD). Further, any number of new technologies may be used for the storage 1058 in addition to, or instead of, the technologies described, such resistance change memories, phase change memories, holographic memories, or chemical memories, among others.

The components may communicate over the interconnect 1056. The interconnect 1056 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1056 may be a proprietary bus, for example, used in a SoC based system. Other bus systems may be included, such as an I²C interface, an SPI interface, point-to-point interfaces, and a power bus, among others.

The interconnect 1056 may couple the processor 1052 to a mesh transceiver 1062, for communications with other mesh devices 1064. The mesh transceiver 1062 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 1064. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 1062 may communicate using multiple standards or radios for communications at different range. For example, the IoT device 1050 may communicate with close devices, e.g., within about 10 meters, using a local transceiver based on BLE, or another low power radio, to save power. More distant mesh devices 1064, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 1066 may be included to communicate with devices or services in the cloud 1000 via local or wide area network protocols. The wireless network transceiver 1066 may be a LPWA transceiver that follows the IEEE 802.15.4, or IEEE 802.15.4g standards, among others. The IoT device 1050 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 1062 and wireless network transceiver 1066, as described herein. For example, the radio transceivers 1062 and 1066 may include an LTE or other cellular transceiver that uses spread spectrum (SPA/SAS) communications for implementing high-speed communications. Further, any number of other protocols may be used, such as Wi-Fi® networks for medium speed communications and provision of network communications.

The radio transceivers 1062 and 1066 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 1066, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 1068 may be included to provide a wired communication to the cloud 1000 or to other devices, such as the mesh devices 1064. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 1068 may be included to allow connect to a second network, for example, a NIC 1068 providing communications to the cloud over Ethernet, and a second NIC 1068 providing communications to other devices over another type of network.

The interconnect 1056 may couple the processor 1052 to an external interface 1070 that is used to connect external devices or subsystems. The external devices may include sensors 1072, such as accelerometers, level sensors, flow sensors, optical light sensors, camera sensors, temperature sensors, global positioning system (GPS) sensors, pressure sensors, barometric pressure sensors, and the like. The external interface 1070 further may be used to connect the IoT device 1050 to actuators 1074, such as power switches, valve actuators, an audible sound generator, a visual warning device, and the like.

In some optional examples, various input/output (I/O) devices may be present within, or connected to, the IoT device 1050. For example, a display or other output device 1084 may be included to show information, such as sensor readings or actuator position. An input device 1086, such as a touch screen or keypad may be included to accept input. An output device 1084 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 1050.

A battery 1076 may power the IoT device 1050, although in examples in which the IoT device 1050 is mounted in a fixed location, it may have a power supply coupled to an electrical grid. The battery 1076 may be a lithium ion battery, or a metal-air battery, such as a zinc-air battery, an aluminum-air battery, a lithium-air battery, and the like.

A battery monitor/charger 1078 may be included in the IoT device 1050 to track the state of charge (SoCh) of the battery 1076. The battery monitor/charger 1078 may be used to monitor other parameters of the battery 1076 to provide failure predictions, such as the state of health (SoH) and the state of function (SoF) of the battery 1076. The battery monitor/charger 1078 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1078 may communicate the information on the battery 1076 to the processor 1052 over the interconnect 1056. The battery monitor/charger 1078 may also include an analog-to-digital (ADC) convertor that allows the processor 1052 to directly monitor the voltage of the battery 1076 or the current flow from the battery 1076. The battery parameters may be used to determine actions that the IoT device 1050 may perform, such as transmission frequency, mesh network operation, sensing frequency, and the like.

A power block 1080, or other power supply coupled to a grid, may be coupled with the battery monitor/charger 1078 to charge the battery 1076. In some examples, the power block 1080 may be replaced with a wireless power receiver to obtain the power wirelessly, for example, through a loop antenna in the IoT device 1050. A wireless battery charging circuit, such as an LTC4020 chip from Linear Technologies of Milpitas, Calif., among others, may be included in the battery monitor/charger 1078. The specific charging circuits chosen depend on the size of the battery 1076, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1058 may include instructions 1082 in the form of software, firmware, or hardware commands to implement the techniques described herein. Although such instructions 1082 are shown as code blocks included in the memory 1054 and the storage 1058, it may be understood that any of the code blocks may be replaced with hardwired circuits, for example, built into an application specific integrated circuit (ASIC).

In an example, the instructions 1082 provided via the memory 1054, the storage 1058, or the processor 1052 may be embodied as a non-transitory, machine-readable medium 1060 including code to direct the processor 1052 to perform electronic operations in the IoT device 1050. The processor 1052 may access the non-transitory, machine-readable medium 1060 over the interconnect 1056. For instance, the non-transitory, machine-readable medium 1060 may be embodied by devices described for the storage 1058 of FIG. 10 or may include specific storage units such as optical disks, flash drives, or any number of other hardware devices. The non-transitory, machine-readable medium 1060 may include instructions to direct the processor 1052 to perform a specific sequence or flow of actions, for example, as described with respect to the flowchart(s) and block diagram(s) of operations and functionality depicted above.

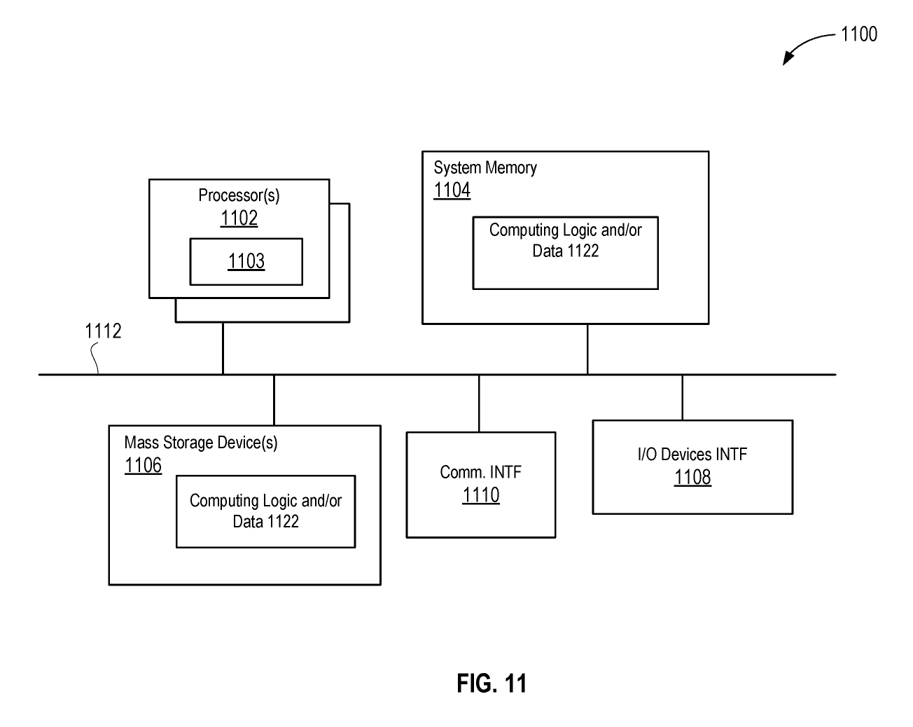

Referring now to FIG. 11, wherein a block diagram of a computer device suitable for practice aspects of the present disclosure, in accordance with various embodiments, is illustrated. As shown, in embodiments, computer device 1100 may include one or more processors 1102, such as for example, an INTEL® XEON® or ATOM® processor, and system memory 1104. Each processor 1102 may include one or more processor cores. In embodiments, one or more processors 1102 may include one or more hardware accelerators (such as, FPGA). System memory 1104 may include any known volatile or non-volatile memory. Additionally, computer device 1100 may include mass storage device(s) 1106 (such as solid state drives), input/output device interface 1108 (to interface with e.g., sensors) and communication interfaces 1110 (such as network interface cards, modems and so forth, to interface with e.g., devices associated with the owner, driver or passenger of the A/SA vehicle). The elements may be coupled to each other via system bus 1112, which may represent one or more buses. In the case of multiple buses, they may be bridged by one or more bus bridges (not shown).

Each of these elements may perform its conventional functions known in the art. In particular, system memory 1104 and mass storage device(s) 1106 may be employed to store a working copy and a permanent copy of the executable code of the programming instructions implementing the operations described earlier, including, but are not limited to, operations associated distributing and performing compute tasks in CA/AD vehicles described earlier with references with FIGS. 8 and 9, CA/AD system of FIG. 7, hosting platform 509, and/or workload outsourcing or distributing service 527, as well as the compute tasks and their associated data, collectively denoted as computing logic and/or data 1122. In one embodiment, the workload outsourcing system may receive a plurality of hosting profiles via communication interfaces 1110, where each of the plurality of hosting profiles including a resource profile combining resources of a plurality of CA/AD vehicles. In embodiments, the hosting profiles may include data based at least in part on historical routes, energy consumption, and content collection corresponding to one or more of the CA/AD vehicles in the plurality. In embodiments, content collection may refer to content collected by one or more sensors.

In embodiments, communication interfaces 1110 may provide the customer workload and the plurality of hosting profiles to the processor, wherein the processor to is to analyze the customer workload and the plurality of hosting profiles; and based at least in part on the analysis, to assign the customer workload to a selected plurality of CA/AD vehicles corresponding to a selected hosting profile. The programming instructions may comprise assembler instructions supported by processor(s) 1102 or high-level languages, such as, for example, C, that can be compiled into such instructions. In embodiments, some of the functions performed by compute engine or processing unit 704 of FIG. 7 may be implemented with hardware processor 1103 instead. In embodiments, one or more processors 1102, system memory 1104 and/or mass storage devices 1106 may be included in a container or enclave to isolate computations associated with a distributed work task as discussed with respect to FIGS. 5-9.

The permanent copy of the executable code of the programming instructions and/or the bit streams to configure hardware accelerator 1103 may be placed into permanent mass storage device(s) 1106 or hardware accelerator 1103 in the factory, or in the field, through, for example, a distribution medium (not shown), such as a compact disc (CD), or through communication interface 1110 (from a distribution server (not shown)).

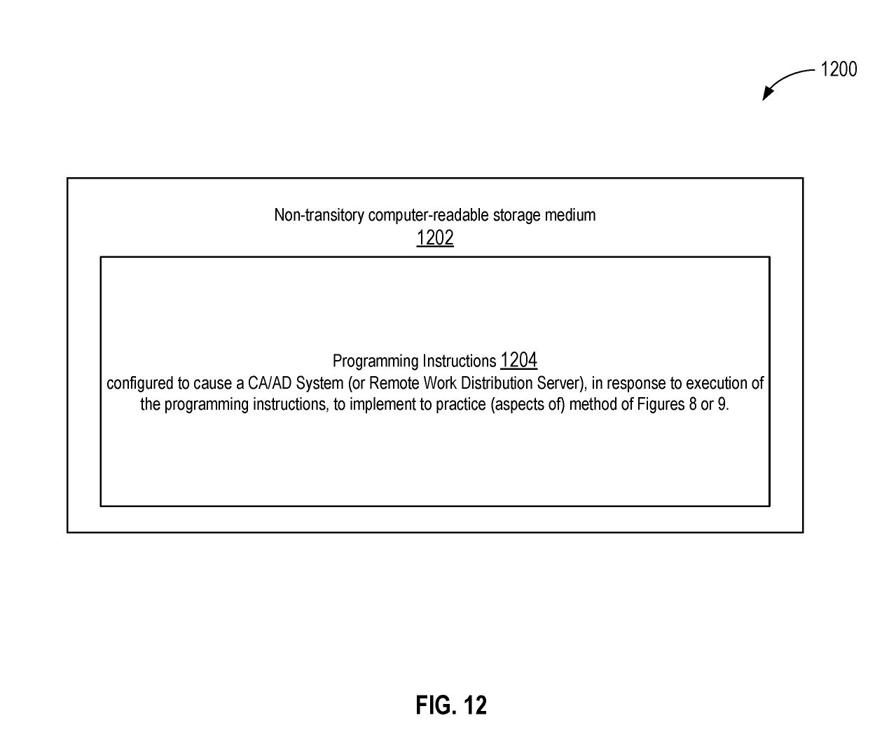

Referring now to FIG. 12, wherein an example non-transitory computer-readable storage medium having instructions configured to practice all or selected ones of the operations associated with assigning and/or performing work on a distributed compute task by a CA/AD system or vehicle, earlier described, in accordance with various embodiments, is shown. As illustrated, non-transitory computer-readable storage medium 1202 may include the executable code of a number of programming instructions 1204. Executable code of programming instructions 1204 may be configured to enable a system, e.g., CA/AD system 700 or computer system 1100, in response to execution of the executable code/programming instructions, to perform, e.g., various operations associated with FIGS. 5-9. In alternate embodiments, executable code/programming instructions 1204 may be disposed on multiple non-transitory computer-readable storage medium 1202 instead. In still other embodiments, executable code/programming instructions 1204 may be encoded in transitory computer readable medium, such as signals.

In embodiments, a processor may be packaged together with a computer-readable storage medium having some or all of executable code of programming instructions 1204 configured to practice all or selected ones of the operations earlier described with references to FIGS. 5-9 For one embodiment, a processor may be packaged together with such executable code 1204 to form a System in Package (SiP). For one embodiment, a processor may be integrated on the same die with a computer-readable storage medium having such executable code 1204. For one embodiment, a processor may be packaged together with a computer-readable storage medium having such executable code 1204 to form a System on Chip (SoC). For at least one embodiment, the SoC may be utilized in, e.g., CA/AD system 700.

Thus, an improved method and apparatus for autonomous or semi-autonomous parking has been described. The approach may be especially helpful for electric vehicles with batteries, such as Li-ion batteries, which useful lives are sensitive to the temperature of their operating conditions.

Example 1 is an apparatus for performing a compute task, comprising a communication interface disposed in a computer-assisted or autonomous driving (CA/AD) vehicle to receive the compute task, wherein the compute task is part of a collection of distributed compute tasks that are assigned to the CA/AD vehicle or other compute apparatuses and each compute task is evaluated based at least in part on resources available to the CA/AD vehicle and to the other computer apparatuses; and a processing unit disposed in the CA/AD vehicle, and coupled to the communication interface to receive the compute task from the communication interface and to perform the compute task using, at least in part, the available resources of the CA/AD vehicle.

Example 2 is the apparatus of Example 1, wherein at least one of the other computer apparatuses is another CA/AD vehicle included in a plurality of CA/AD vehicles.

Example 3 is the apparatus of Example 2, wherein the resources available to the CA/AD vehicle and the at least one other CA/AD vehicle include compute system resources and/or sensor data resources.

Example 4 is the apparatus of Example 3 wherein the compute system resources include a selected one or more of available computational power, storage, and trusted hardware and information related to the compute system resources are included in a compute system resource profile of a corresponding CA/AD vehicle.

Example 5 is the apparatus of Example 3, wherein the sensor data resources include resources related to externalities detected by sensors of the CA/AD vehicle or the at least one other CA/AD vehicle and are related to network connectivity, location, predictable location, and wherein information related to the sensor data resources are included in a sensor data resource profile of a corresponding CA/AD vehicle.

Example 6 is the apparatus of Example 3, wherein the communication interface to form a network with the at least one other CA/AD vehicle based at least in part on a predictable physical proximity to the at least one other CA/AD vehicle and a physical proximity to a high bandwidth network, and wherein the CA/AD vehicles to be assigned to a similar workload related to the compute task.

Example 7 is the apparatus of Example 6, wherein the resources of the CA/AD vehicles are available when the CA/AD vehicles are parked.

Example 8 is the apparatus of Example 2, wherein each of the CA/AD vehicles comprises a blockchain processing node to assist in amalgamating and maintaining a collective hosting profile based at least in part on resource profiles of individual CA/AD vehicles of the plurality of CA/AD vehicles.

Example 9 is the apparatus of Example 2, wherein the processing unit further to receive historical information from the at least one other CA/AD vehicle and to analyze the historical information to predict an availability of the resources of the at least one other CA/AD vehicles to assist in pairing the CA/AD vehicles to jointly perform the compute tasks.

Example 10 is the apparatus of Example 9, wherein the processing unit is to register a hosting profile, based at least in part on collective resources and the historical information with an external server, to indicate that the plurality of CA/AD vehicles is available to receive a workload from a customer.

Example 11 is the apparatus of Example 10, wherein the processing unit is further to partition resources of the plurality to indicate that the group is available to support a plurality of workloads.

Example 12 is the apparatus of Example 11, wherein the plurality of workloads corresponds to a plurality of containers, each container encapsulating a corresponding workload.

Example 13 is the apparatus of any one of Examples 1-12, wherein the apparatus is a computer-assisted or autonomous driving system disposed in the CA/AD vehicle, and further is coupled to receive sensor data, via the communication interface, from sensors of the CA/AD vehicle related to the availability of the CA/AD resources, and wherein the sensor data comprises at least one of camera data, RADAR data, light detection and ranging (LIDAR) data, radiation temperature data, or Global Positioning System data.

Example 14 is the apparatus of any one of Examples 1-13, wherein the apparatus is the CA/AD vehicle and comprising the autonomous driving system and driving elements coupled to the autonomous driving system, including one or more of an engine, electric motor, braking system, drive system, wheels, transmission, and a battery.

Example 15 is the apparatus of any one of Examples 1-14, wherein the processing unit comprises a field-programmable gate array programmable based at least in part on a workload related to the compute task.

Example 16 is a method for assigning a workload, comprising: receiving, at a workload management server, a customer workload request; receiving, at the workload management server, a plurality of resource profiles corresponding to a plurality of hosting platforms each including a plurality of CA/AD vehicles; and analyzing, by the workload management server, the workload request and the plurality of resource profiles; and assigning a workload related to the workload request to a selected hosting platform, based at least in part on the analysis.

Example 17 is the method of Example 16, wherein the analyzing, by the workload management server, the workload request, includes matching one or more of the plurality of resource profiles to one or more of a plurality of customer workloads based on information related to resources including at least one of predictably available energy, compute power, storage, and sensor data.

Example 18 is the method of Example 16, further comprising, transmitting information related to the workload to the selected hosting platform for performance of the workload by the plurality of CA/AD vehicles included in the hosting platform.

Example 19 is the method of Example 16, further comprising, receiving authentication of resources of the CA/AD vehicles in the plurality via remote attestation.

Example 20 is at least one computer-readable medium (CRM) comprising a plurality of instructions arranged to cause a computer-assisted or autonomous driving system disposed in a vehicle, in response to execution of the instructions, to: indicate an availability to perform a compute task; receive the compute task, wherein the compute task is a distributed compute task that is assigned to the vehicle based at least in part on resources available to the CA/AD vehicle and other compute apparatuses; and perform the compute task.

Example 21 is the CRM of Example 20, wherein to indicate the availability to perform the compute task comprises to register the availability with a network of a plurality of other vehicles that are similarly available to perform a workload related to the compute task.

Example 22 is the CRM of any one of Examples 20-21, further comprising to perform the compute task within a trusted hardware environment.

Example 23 is a workload out-sourcing system, comprising: a processor; a memory; and a network interface coupled to the processor and the memory to: receive a customer workload; receive a plurality of hosting profiles, each of the plurality of hosting profiles including a resource profile combining resources of a plurality of CA/AD vehicles; and provide the customer workload and the plurality of hosting profiles to the processor, wherein the processor to: analyze the customer workload and the plurality of hosting profiles; and based at least in part on the analysis, to assign the customer workload to a selected plurality of CA/AD vehicles corresponding to a selected hosting profile.

Example 24 is the workload out-sourcing system of Example 23, comprising a remote server located in an enhanced data for global system for mobile communications (EDGE) network and further comprising the CA/AD vehicles, communicatively coupled to the remote server.

Example 25 is the workload out-sourcing system of any one of Examples 23-24, wherein the network interface further to receive completed work related to the customer workload from one or more of the CA/AD vehicles and to transmit data related to payment to an owner of one or more of the CA/AD vehicles in the plurality.

Example 26 is an apparatus including means for: receiving a customer workload request; receiving a plurality of resource profiles corresponding to a plurality of hosting platforms each including a plurality of CA/AD vehicles; analyzing the workload request and the plurality of resource profiles; and assigning a workload related to the workload request to a selected hosting platform, based at least in part on the analysis.

Example 27 is the apparatus of Example 26, further comprising, means for receiving authentication of resources of the CA/AD vehicles in the plurality via remote attestation.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus for performing a compute task, comprising:
a communication interface disposed in a computer-assisted or autonomous driving (CA/AD) vehicle to receive the compute task, wherein the compute task is part of a collection of distributed compute tasks that are assigned to the CA/AD vehicle or other compute apparatuses and each compute task is evaluated based at least in part on resources available to the CA/AD vehicle and to the other computer apparatuses; and
a processing unit disposed in the CA/AD vehicle, and coupled to the communication interface to receive the compute task from the communication interface and to perform the compute task using, at least in part, the available resources of the CA/AD vehicle.

2. The apparatus of claim 1, wherein at least one of the other computer apparatuses is another CA/AD vehicle included in a plurality of CA/AD vehicles.

3. The apparatus of claim 2, wherein the resources available to the CA/AD vehicle and the at least one other CA/AD vehicle include compute system resources and/or sensor data resources.

4. The apparatus of claim 3 wherein the compute system resources include a selected one or more of available computational power, storage, and trusted hardware and information related to the compute system resources are included in a compute system resource profile of a corresponding CA/AD vehicle.

5. The apparatus of claim 3, wherein the sensor data resources include resources related to externalities detected by sensors of the CA/AD vehicle or the at least one other CA/AD vehicle and are related to network connectivity, location, predictable location, and wherein information related to the sensor data resources are included in a sensor data resource profile of a corresponding CA/AD vehicle.

6. The apparatus of claim 3, wherein the communication interface to form a network with the at least one other CA/AD vehicle based at least in part on a predictable physical proximity to the at least one other CA/AD vehicle and a physical proximity to a high bandwidth network, and wherein the CA/AD vehicles to be assigned to a similar workload related to the compute task.

7. The apparatus of claim 6, wherein the resources of the CA/AD vehicles are available when the CA/AD vehicles are parked.

8. The apparatus of claim 2, wherein each of the CA/AD vehicles comprises a blockchain processing node to assist in amalgamating and maintaining a collective hosting profile based at least in part on resource profiles of individual CA/AD vehicles of the plurality of CA/AD vehicles.

9. The apparatus of claim 2, wherein the processing unit further to receive historical information from the at least one other CA/AD vehicle and to analyze the historical information to predict an availability of the resources of the at least one other CA/AD vehicles to assist in pairing the CA/AD vehicles to jointly perform the compute tasks.

10. The apparatus of claim 9, wherein the processing unit is to register a hosting profile, based at least in part on collective resources and the historical information with an external server, to indicate that the plurality of CA/AD vehicles is available to receive a workload from a customer.

11. The apparatus of claim 10, wherein the processing unit is further to partition resources of the plurality to indicate that the group is available to support a plurality of workloads.

12. The apparatus of claim 11, wherein the plurality of workloads corresponds to a plurality of containers, each container encapsulating a corresponding workload.

13. The apparatus of claim 1, wherein the apparatus is a computer-assisted or autonomous driving system disposed in the CA/AD vehicle, and further is coupled to receive sensor data, via the communication interface, from sensors of the CA/AD vehicle related to the availability of the CA/AD resources, and wherein the sensor data comprises at least one of camera data, RADAR data, light detection and ranging (LIDAR) data, radiation temperature data, or Global Positioning System data.

14. The apparatus of claim 13, wherein the apparatus is the CA/AD vehicle and comprising the autonomous driving system and driving elements coupled to the autonomous driving system, including one or more of an engine, electric motor, braking system, drive system, wheels, transmission, and a battery.

15. The apparatus of claim 1, wherein the processing unit comprises a field-programmable gate array programmable based at least in part on a workload related to the compute task.

16. A method for assigning a workload, comprising:
receiving, at a workload management server, a customer workload request;
receiving, at the workload management server, a plurality of resource profiles corresponding to a plurality of hosting platforms each including a plurality of CA/AD vehicles; and
analyzing, by the workload management server, the workload request and the plurality of resource profiles; and
assigning a workload related to the workload request to a selected hosting platform, based at least in part on the analysis.

17. The method of claim 16, wherein the analyzing, by the workload management server, the workload request, includes matching one or more of the plurality of resource profiles to one or more of a plurality of customer workloads based on information related to resources including at least one of predictably available energy, compute power, storage, and sensor data.

18. The method of claim 16, further comprising, transmitting information related to the workload to the selected hosting platform for performance of the workload by the plurality of CA/AD vehicles included in the hosting platform.

19. The method of claim 16, further comprising, receiving authentication of resources of the CA/AD vehicles in the plurality via remote attestation.

20. At least one computer-readable medium (CRM) comprising a plurality of instructions arranged to cause a computer-assisted or autonomous driving system disposed in a vehicle, in response to execution of the instructions, to:
indicate an availability to perform a compute task;
receive the compute task, wherein the compute task is a distributed compute task that is assigned to the vehicle based at least in part on resources available to the CA/AD vehicle and other compute apparatuses; and
perform the compute task.

21. The CRM of claim 20, wherein to indicate the availability to perform the compute task comprises to register the availability with a network of a plurality of other vehicles that are similarly available to perform a workload related to the compute task.

22. The CRM of claim 20, further comprising to perform the compute task within a trusted hardware environment.

23. A workload out-sourcing system, comprising:
a processor;
a memory; and
a network interface coupled to the processor and the memory to:
receive a customer workload;
receive a plurality of hosting profiles, each of the plurality of hosting profiles including a resource profile combining resources of a plurality of CA/AD vehicles; and
provide the customer workload and the plurality of hosting profiles to the processor, wherein the processor to:
analyze the customer workload and the plurality of hosting profiles; and
based at least in part on the analysis, to assign the customer workload to a selected plurality of CA/AD vehicles corresponding to a selected hosting profile.

24. The workload out-sourcing system of claim 23, comprising a remote server located in an enhanced data for global system for mobile communications (EDGE) network and further comprising the CA/AD vehicles, communicatively coupled to the remote server.

25. The workload out-sourcing system of claim 23, wherein the network interface further to receive completed work related to the customer workload from one or more of the CA/AD vehicles and to transmit data related to payment to an owner of one or more of the CA/AD vehicles in the plurality.
